(19) United States
(12) Patent Application Publication
(10) Pub. No.: US 2006/0248267 A1
(43) Pub. Date: Nov. 2, 2006

(54) Flash memory having configurable sector size and flexible protection scheme

(75) Inventor: Jianhui Xie, Milpitas, CA (US)

Correspondence Address: MACPHERSON KWOK CHEN & HEID LLP, 1762 TECHNOLOGY DRIVE, SUITE 226, SAN JOSE, CA, 95110, US

(73) Assignee: Programmable Microelectronics Corporation

(21) Appl. No.: 11/119,041

(22) Filed: Apr. 29, 2005

(51) Int. Cl. G06F 12/00

(52) U.S. Cl. 711/103

(57) ABSTRACT

Methods and systems are provided for a flash memory device having a configurable sector size and a flexible protection scheme. A flash memory circuit includes: a memory array including a plurality of memory sectors, wherein at least one of the memory sectors includes a plurality of subsectors; a status register array including a plurality of protection bits defining a protection scheme for the memory array; a configuration register array defining a protection scheme for the plurality of subsectors, said configuration register including a subsector enable bit and a plurality of subsector protection bits; and control logic for controlling storage of data on the memory array.

### BACKGROUND OF THE INVENTION

A flash memory device includes a memory array for storing data in a nonvolatile form. Typical flash memory arrays are divided into a plurality of sectors, where each sector can store a plurality of bytes of data, and feature byte-programming and sector-erase capability. As a result, when the control logic for the flash memory device needs to store a single byte of data, an entire sector must first be erased, with the new data stored byte by byte. A protection scheme is generally used to protect one or more sectors from being erased or programmed. An attribute memory may be used to store information regarding the protection of data for flash memory. Due to the frequency with which the attribute memory needs to be accessed, the attribute memory is often implemented in EEPROM instead of flash memory.

Flash memory devices have increasingly been used for storing both code and user data for electronic devices, such as cellular phones and LCD displays. In these applications, the code stored on the flash memory device rarely changes and should generally be protected against unauthorized modification to avoid corruption of the code. However, the user data may be changed frequently by the user, such as when a user adjusts the display settings for an LCD display.

In many flash memory devices, the data protection scheme protects the entire memory array or large portions of the memory array as a group. Thus, when it is desired to store a single byte of data in the user data portion of the memory array, the entire protection group must be unprotected. Then, an entire sector within the protection group is erased and reprogrammed with the new byte of data and the preexisting data from that sector. If an error occurs during this operation, the wrong sector may be erased and rewritten, causing the code portion of the memory array to become corrupted.

It would therefore be desirable to implement a protection scheme for the flash memory device that adequately protects certain portions of the memory array, such as the portions containing code, while allowing modifications to the other portions, such as the user data portion of the memory array.

### SUMMARY OF THE INVENTION

In accordance with embodiments of the present invention, a method of storing data in a flash memory device comprising a memory array is provided. The memory array comprises a plurality of memory sectors, wherein at least one of the memory sectors comprises a plurality of subsectors. The method comprises: receiving an instruction to erase an address contained in one of the plurality of subsectors; checking a subsector enable bit in a configuration register; if the subsector enable bit is not enabled, applying a first protection scheme to determine write protection of the address; and if the subsector enable bit is enabled, applying a second protection scheme to determine write protection of the address, wherein the second protection scheme permits the control logic to unprotect a single subsector without unprotecting a remainder of the memory array.

In accordance with other embodiments of the present invention, a flash memory circuit is provided, comprising: a memory array comprising a plurality of memory sectors, wherein at least one of the memory sectors comprises a plurality of subsectors; a status register array comprising a plurality of protection bits defining a protection scheme for the memory array; a configuration register array defining a protection scheme for the plurality of subsectors, said configuration register comprising a subsector enable bit and a plurality of subsector protection bits; and control logic for controlling storage of data on the memory array.

In accordance with other embodiments of the present invention, a flash memory circuit is provided, comprising: a memory array comprising a plurality of memory sectors, wherein at least one of the memory sectors comprises a plurality of subsectors; a configuration register array comprising a subsector enable bit; and control logic for controlling storage of data on the memory array, said control logic configured such that if the subsector enable bit is enabled, the control logic performs erase instructions on a subsector level, and if the subsector enable bit is disabled, the control logic performs erase instructions on a sector level.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### DESCRIPTION OF THE DRAWINGS

FIG. 1 is a functional block diagram of a flash memory device, in accordance with embodiments of the present invention.

FIG. 2 is a connection diagram for an 8-pin SOIC package, which can be used as part of the flash memory device, in accordance with embodiments of the present invention.

FIG. 3 is a block diagram showing a memory array divided into N sectors.

FIG. 4 shows the memory array with the subsector feature enabled, in accordance with embodiments of the present invention.

FIG. 5 shows a configuration register format table, in accordance with embodiments of the present invention.

FIG. 6 shows a status register format table, in accordance with embodiments of the present invention.

FIG. 7 is a table illustrating a memory protection scheme, in accordance with embodiments of the present invention.

FIG. 8 is a table illustrating the instruction set for a flash memory device, in accordance with embodiments of the present invention.

FIG. 9 shows a flowchart for performing erase commands on a memory array 110 having sectors that are configurable into subsectors, in accordance with embodiments of the present invention.

FIG. 10 is a block diagram of a flash memory device implemented as part of a LCD display device, in accordance with embodiments of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

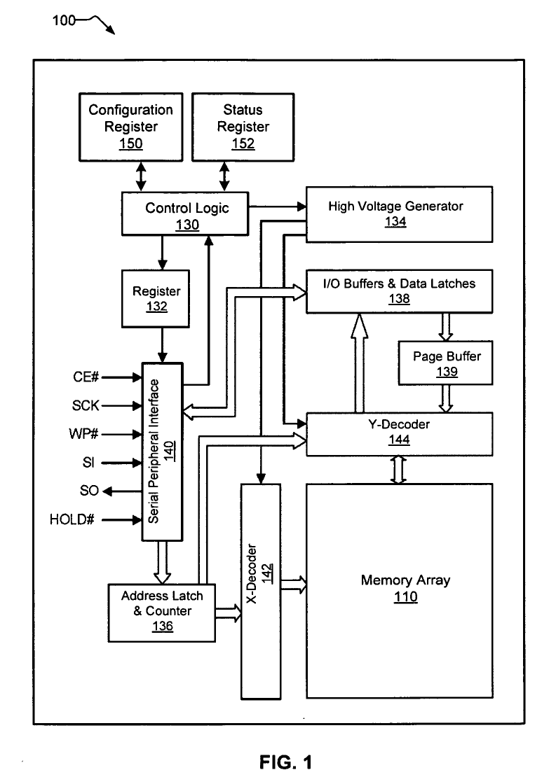

FIG. 1 is a functional block diagram of a flash memory device 100, in accordance with embodiments of the present invention. Data is stored in a plurality of flash memory cells of a memory array 110. The flash memory device 100 also includes a register 132, a high voltage generator 134, an address latch and counter 136, I/O buffers and data latches 138, a 256 byte page buffer 139, a Serial Peripheral Interface (SPI) 140, an X-decoder 142, a Y-decoder 144, a configuration register 150, and a status register 152. Control logic 130 controls the operation of the flash memory device 100 and enables the flash memory device 100 to pass data to and from the memory array 110 via the I/O buffers 138. The address latch 136 stores the address for each read/write operation. The address stored in the address latch 136 is used by the X-decoder 142 to decode the row address in the memory array 110 and the Y-decoder 144 to decode the column address in the memory array 110. The data latch 138 latches data being written to or read from the memory array 110.

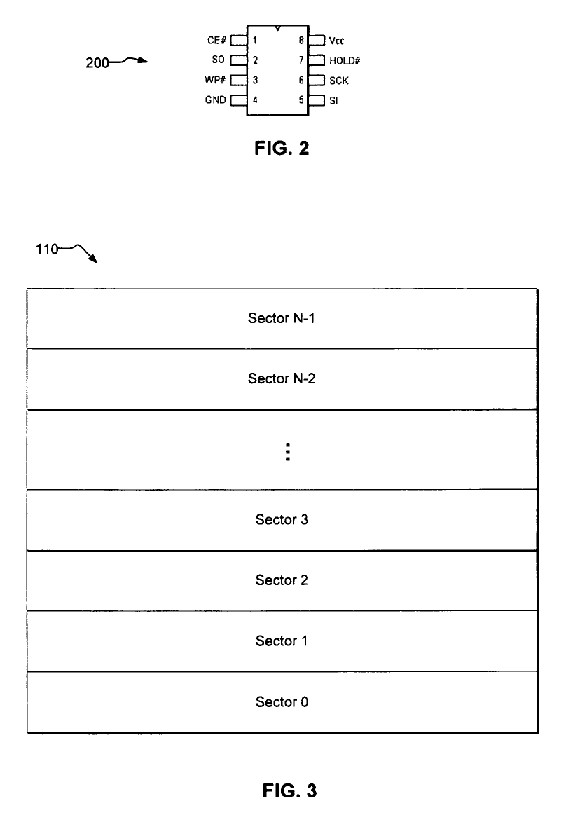

FIG. 2 is a connection diagram for an 8-pin SOIC (small outline integrated circuit) package 200, which can be used for the flash memory device 100. Pin CE# is a chip enable terminal. A low input on pin CE# activates the flash memory device's internal circuitries for device operation. A high input on pin CE# deselects the device, causing the device to switch into standby mode to reduce power consumption. When pin CE# is high, data will not be accepted on the serial input pin (pin SI) and the serial output pin (pin SO) will remain in a high impedance state. Pin WP# is a write protect pin that provides a hardware program/erase protection for the status register 152. The flash memory device 100 is configured to interface directly with the synchronous Serial Peripheral Interface (SPI) of a controller, such as, e.g., MC68HCxx series of microcontrollers by the Motorola, Inc., of Schaumberg, Ill. In other embodiments, the flash memory device 100 may include an interface according to a different interface protocol, such as, e.g., IEEE 1394, etc.

In accordance with embodiments of the present invention, the flash memory device 100 provides a configurable sector size for a region of the memory array 110. This configurable region may comprise all of the memory array 110, a portion of the memory array 110, or a single sector of the memory array 110. The subsector configuration can be enabled through specific software instructions and the configuration register 150, as will be described in greater detail below.

FIG. 3 is a block diagram showing the memory array 110 divided into N sectors, numbered Sector 0 through Sector N−1. In this embodiment, each sector in the memory array 110 stores 4 kilobytes (KB) of data, with the entire memory array 110 including 128 sectors to store a total of 4 megabits (4 Mb or 512 KB) of data. These sectors can be grouped into 8 blocks, with each block including 16 adjacent sectors or 64 KB of data.

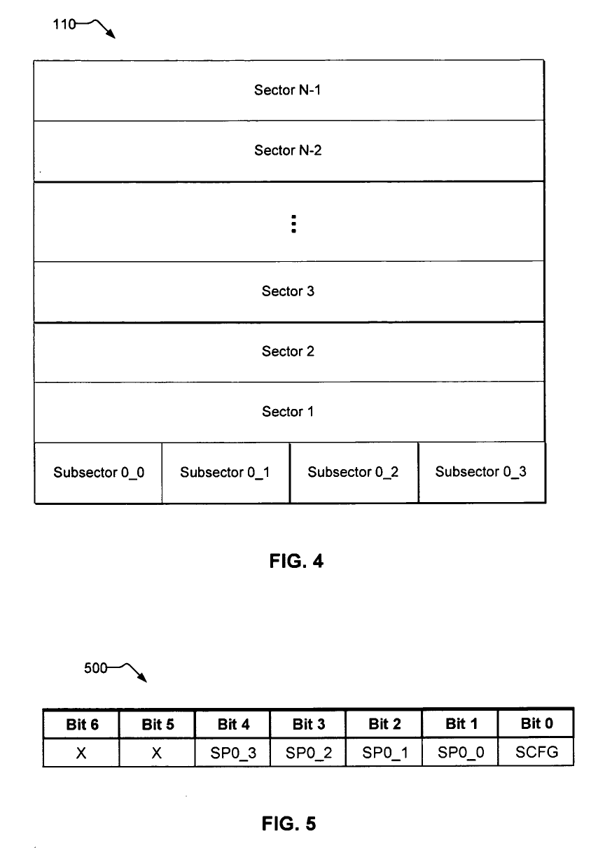

FIG. 4 shows the memory array 110 with the subsector feature enabled, such that the bottom sector (Sector 0) of the memory array 110 is configured into four 1 KB subsectors (Subsector 0_0, Subsector 0_1, Subsector 0_2, and Subsector 0_3). In this embodiment, only the bottom sector (Sector 0) is configurable from the full sector size of 4 KB into four subsectors of 1 KB each. In other embodiments, multiple sectors may be configured to be dynamically configured into subsectors in the same way as Sector 0.

When the subsector feature is enabled, each of the Subsectors 0_0 through 0_3 can be unprotected, erased, and rewritten separately from the other subsectors and sectors in the memory array 110. Thus, in order to reprogram subsector 0_0, the other subsectors 0_1 through 0_3 and sectors 1 through N−1 can remain protected while the subsector 0_0 is erased and reprogrammed.

FIG. 5 shows a configuration register format table 500 stored in the configuration register 150 that may be used to enable the subsector configuration shown in FIG. 4 and to protect the data contained in the subsectors, in accordance with one embodiment. The configuration register 150 stores bits of data which are used by the control logic 130 in controlling erase and write access to the memory array 110. A subsector enable bit, shown in FIG. 4 as Bit 0 labeled Sector Configuration (SCFG), defines whether the subsector feature is enabled. A plurality of subsector protection bits, shown in FIG. 4 as Bits 1-4 (labeled SP0_0, SP0_1, SP0_2, and SP0_3), define the erase protection provided to each of the individual subsectors. Bits 5-6 are reserved for future use.

In this embodiment, when the SCFG bit is set to “0”, Sector 0 is treated as a single 4 KB sector by the control logic 130. When the SCFG bit is set to “1”, Sector 0 is treated as four separate 1 KB sectors. For each of the protection bits, a “0” value indicates that the write protection is disabled for that subsector and a “1” value indicates that the write protection is enabled.

In FIG. 5, a single row of 5 bits may be used to activate and control the subsector configuration of the bottom sector, Sector 0. In other embodiments where more than a single sector is reconfigurable into subsectors, multiple rows of 5 bits each may be used, with each row corresponding to a single sector. In yet other embodiments, other arrangements of bits may be used to store the configuration register 150.

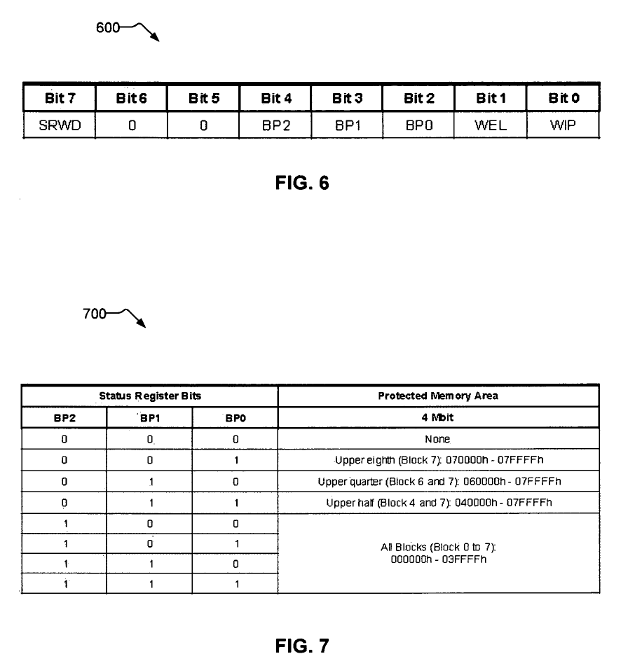

FIG. 6 shows a status register format table 600 that may be used to control the default data protection scheme for the memory array 110. Bit 0 is a “Write in Progress” bit which holds a value of “0” when the device 100 is available and a value of “1” when a write cycle is in progress and the device 100 is busy. Bit 1 is a “Write Enable Latch” which holds a default value of “0” to indicate that the device 100 is not write enabled and a value of “1” to indicate that the device 100 is write enabled. Bits 2-4 are “Block Protection” bits that indicate whether specific blocks within the memory array 110 are write protected, as will be described in greater detail below with respect to FIG. 7. Bit 7 is a “Status Register Write Disable” (SRWD) bit that is operated in conjunction with the Write Protection (WP#) signal to provide a hardware protection mode for the status register 152. When the SRWD bit is set to the default value of “0”, the status register 152 is not write protected. When the value is “1” and the WP# terminal is pulled low (V_{IL}), the non-volatile bits of the status register 152 (i.e., SRWD, BP2, BP1, and BP0) become read-only and any attempts to write to the status register 152 will be prohibited. Bits 5-6 are reserved for future use.

FIG. 7 is a table 700 illustrating a memory protection scheme utilizing the status register protection bits BP0, BP1, and BP2. As shown in table 700, depending on the values of bits BP0, BP1, and BP2, software write protection is provided to either none, the upper eighth, the upper quarter, the upper half, or all blocks of the memory array 110. In the illustrated embodiment, the memory array 110 includes 128 sectors divided into 8 blocks of 16 sectors each. Thus, if the software protection is applied to the upper eighth of the memory array 110, all of block 7 (i.e., the top sixteen sectors in the array 110) will be protected from write operations. Similarly, if the protection is applied to the upper quarter of the array 110, all of blocks 6 and 7 (i.e., the top 32 sectors in the array 110) will be protected.

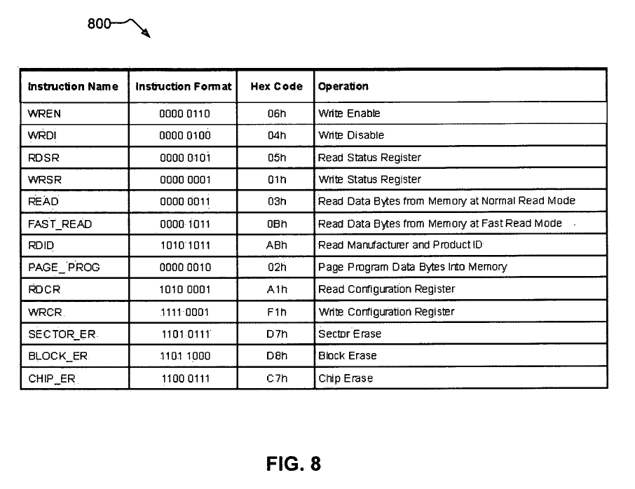

FIG. 8 is a table 800 illustrating the instruction set for the flash memory device 100. The device 100 utilizes an 8-bit instruction register. All instructions, addresses, and data are shifted in with the most significant bit (MSB) first on the Serial Data Input (SI) pin. The input data on the SI pin is latched on the rising edge of the Serial Clock (SCK) signal after the Chip Enable (CE#) pin is driven low (to V_{IL}). Every instruction sequence begins with a one-byte instruction code, which may be followed by address bytes, data bytes, or both address and data bytes, depending on the type of instruction received. The CE# is driven high (to V_{IH}) after the last bit of the instruction sequence has been shifted in.

The “Read Product Identification” (RDID) instruction allows the user to read the manufacturer and product ID of the flash memory device.

The “Write Enable” (WREN) instruction is used to set the WEL bit (Bit 1 in FIG. 6) of the status register 152. The WEL bit defaults to the write disable state (“0”) at initial power-up of the device 100. The WEL bit is enabled before any write operation, including the Sector Erase, Block Erase, Chip Erase, Page Program, Write Status Register, and Write Configuration Register operations, can be executed. The WEL bit is reset back to the write disable state (“0”) automatically after the completion of a write operation.

To protect the device 100 against inadvertent writes, the “Write Disable” (WRDI) instruction resets the WEL bit and disables all write instructions. The WRDI instruction is not required after the execution of a write instruction because WEL will be automatically reset after the write operation is completed.

The “Read Status Register” (RDSR) instruction provides access to the status register 152. During the execution of a program, erase or write status register operation, all other instructions will be ignored except the RDSR instruction. The RDSR can be used for detecting the progress or completion of the operations by reading the WIP bit of status register 152.

The “Write Status Register” (WRSR) instruction allows the user to enable or disable the block protection and status register write protection features by writing “0” or “1” values into the non-volatile BP2, BP1, BP0 and SRWD bits of the status register 152.

The “Read Configuration Register” (RDCR) instruction provides access to the configuration register 150. This RDCR instruction can be used to verify the configuration setting of the bottom Sector 0 and the write protection settings for each individual 1 Kbyte subsector (Sector 0_0 through Sector 0_3).

The “Write Configuration Register” (WRCR) instruction allows the user to enable or disable the block protection and status register write protection features by writing “0” or “I” values into the non-volatile BP2, BP1, BP0 and SRWD bits of the configuration register 150.

The “Read Data” (READ) instruction is used to read memory data from the memory array 110 during normal clock mode (e.g., 50 MHz). If the device 100 is configured in turbo mode (e.g., 66 MHz), the READ instruction will be disabled and the FAST_READ instruction should be used instead. The READ instruction is activated by pulling the CE# line of the selected device to low (V_{IL}), and transmitting the READ instruction code via the SI line followed by a three byte address (A23-A0) corresponding to the portion of the memory array 110 to be read.

The “Fast Read” (FAST_READ) instruction is used to read memory data in either normal or turbo mode The FAST_READ instruction code is followed by a three byte address (A23-A0) and a dummy byte (8 clocks), transmitted via the SI line, with each bit being latched-in during the rising edge of SCK.

The “Page Program” (PAGE_PROG) instruction allows up to 256 bytes of data to be programmed into the memory array 110 using a single program operation. If a PAGE_PROG instruction attempts to program into a page containing a sector or subsector that is write protected, the instruction will be ignored. Before the execution of PAGE_PROG instruction, the Write Enable Latch (WEL) is enabled through a Write Enable (WREN) instruction. The PAGE_PROG instruction is activated by pulling the CE# line low to select the device 100, and shifting in the PAGE_PROG instruction code, three address bytes and program data (1 to 256 bytes) to be programmed via the SI line. The Program operation will start immediately after the CE# is brought high. The internal control logic 130 automatically handles the programming voltages and timing. During a program operation, all instructions will be ignored except the RDSR instruction. The progress or completion of the program operation can be determined by reading the WIP bit in the status register 152 through a RDSR instruction. If the WIP bit is “1”, the program operation is still in progress. If the WIP bit is “0”, the program operation has completed. A Page Program operation can be used to change a “1” value into a “0” value, but an erase operation is used to change a “0” value back to a “1”. The same byte cannot be reprogrammed without erasing the whole sector or block first.

As described above, the memory array 110 is organized into uniform 4 KB sectors or 64 KB uniform blocks comprising 16 adjacent sectors. The bottom sector (Sector 0) of the device 100 can be configured into four 1 KB subsectors. Before a byte can be reprogrammed, the sector or block which contains the target byte is first erased. In the illustrated embodiment, three erase instructions can be used to erase bytes in the memory array 110: “Sector Erase” (SECTOR_ER), “Block Erase” (BLOCK_ER), and “Chip Erase” (CHIP_ER). A Sector Erase operation is used to erase any individual sector without affecting the data in other sectors. A Block Erase operation is used to erase an individual block. A Chip Erase operation is used to erase the entire memory array 110.

A SECTOR_ER instruction is used to erase a single 4 KB sector or a single 1 KB subsector (Subsector 0_3, Subsector 0_2, Subsector 0_1, or Subsector 0_0), if the subsector feature has been enabled. Before the execution of SECTOR_ER instruction, the Write Enable Latch (WEL) is enabled through a Write Enable (WREN) instruction. The WEL will be reset automatically after the completion of Sector Erase operation. The SECTOR_ER instruction is entered, after the CE# is pulled low to select the device, by shifting in the SECTOR_ER instruction code and three address bytes via the SI. The Erase operation will begin immediately after the CE# is pulled high, otherwise the SECTOR_ER instruction will not be executed. The internal control logic automatically handles the erase voltage and timing. During an Erase operation, all other instructions will be ignored except the Read Status Register (RDSR) instruction. The progress or completion of the Erase operation can be determined by reading the WIP bit in status register 152 through a RDSR instruction.

A “Block Erase” (BLOCK_ER) instruction erases a 64 KB block in a single operation. Before the execution of the BLOCK_ER instruction, the Write Enable Latch (WEL) is enabled through a Write Enable (WREN) instruction. Again, the WEL will be reset automatically after the completion of Block Erase operation.

A “Chip Erase” (CHIP_ER) instruction erases the entire memory array 110 of the device 100. Before the execution of a CHIP_ER instruction, the WEL is enabled through a WREN instruction.

The flash memory device 100 has two protection modes, hardware write protection and software write protection, to protect the data integrity and prevent any undesired operations to be executed as a result of potential external factors.

The device 100 provides two types of hardware write protection. First, when any Program, Erase, or Write status register instructions are received, the number of clock pulses will be checked to confirm that it is a multiple of eight before the execution of such instruction. Any incomplete instruction command sequence will be ignored. Second, the device 100 includes a Write Protection (WP#) pin to provide hardware write protection for the status register 152.

The flash memory device 100 also includes three software write protection features. First, before the execution of any Program, Erase, or Write Status Register instruction, the WEL bit must be enabled by execution of the WREN instruction. If the WEL bit is not enabled, the Program, Erase, or Write Status Register instruction will be ignored. Second, the block protection bits (BP2, BP1, BP0) in the configuration register 150 control the write protection for the memory array 110. Third, the subsector enable bit (SCFG) and subsector protection bits (SP0_0, SP0_1, SP0_2, and SP0_3) in the configuration register 150 control the write protection of the subsectors in the configurable bottom sector, Sector 0.

When the flash memory device 100 is initially powered up, the configuration register array is established using data latches in the configuration register 150. By default, at power-up all the bits (Bits 0-7) in the configuration register 150 are set to “0”. Accordingly, the memory array 110 is organized using the default sector size, e.g., uniform sectors of 4 KB each. Because the subsector feature is not enabled, the subsector protection bits SP0_0 through SP0_3 are not used. The protection for the memory array 110 is defined by the default protection scheme, as established by the protection bits BP0, BP1, and BP2 of the status register 152.

As described above, the configuration register 150 can be used to configure one or more sectors in the memory array 110 into a plurality of subsectors. A subsector protection scheme may be provided for establishing separate protection states for each of these subsectors.

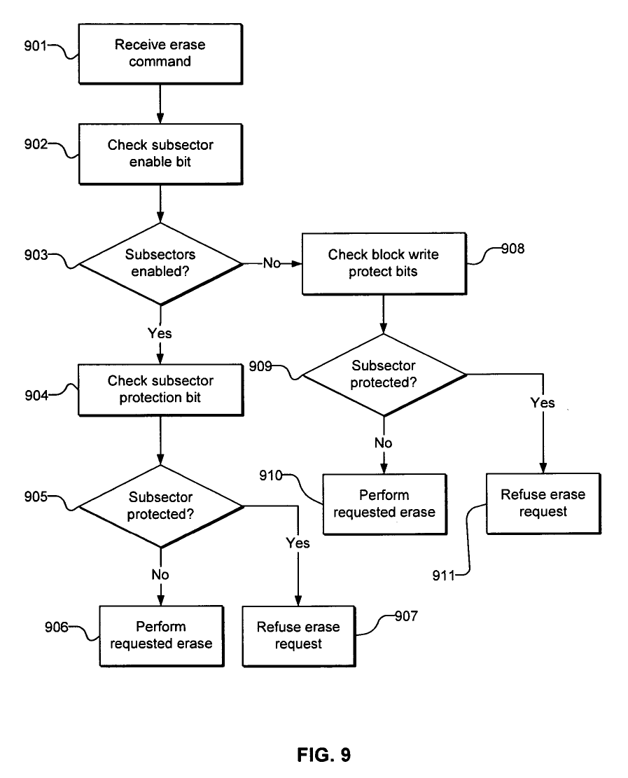

FIG. 9 shows a flowchart for performing erase commands on a memory array 110 having sectors that are configurable into subsectors, in accordance with embodiments of the present invention. In step 901, an erase command is received. This erase command may be in the form of an Sector Erase (SECTOR_ER) instruction received by the control logic 130, as described above with respect to FIG. 8.

In step 902, the subsector enable bit corresponding to the address targeted by the erase command is checked. In order to enable the subsector feature and configure the sector into multiple subsectors, a Write Confirmation Register (WCR) instruction is issued to change the value of the SCFG bit to “1”. Each time an Erase instruction is received for an address located within the subsector configurable region of the memory array 110, the control logic 130 checks the subsector enable bit corresponding to the target address. In the illustrated example, only a single sector (Sector 0) is configurable into subsectors and a single enable bit (SCFG) is used to indicate the configuration of the sector. Thus, when an Erase instruction is issued for an address within Sector 0, the control logic 130 checks Bit 0 in the configuration register 150 in order to determine whether the SCFG bit is enabled. In order to disable the subsector feature, a WCR instruction can be issued to change the value of the SCFG bit back to “0”.

If the SCFG bit is enabled, then the control logic 130 will proceed with determining whether the targeted subsector is write protected by checking the subsector protection bit in step 904. If the subsector protection bit is “0”, then the targeted subsector is unprotected and the control logic 130 will proceed in step 906 with executing the Erase instruction. If the subsector protection bit is “1”, then the subsector is write protected and the Erase instruction will be refused in step 907. In some embodiments, the Erase instruction is simply ignored by the control logic 130. In other embodiments, the control logic 130 issues a error message indicating that the Erase instruction has been refused. The same process for subsector write protection is also used for the Block Erase and Chip Erase commands.

If the SCFG bit is not enabled, then the default protection scheme is applied. In the illustrated embodiment, the default protection scheme is defined by the protection bits BP0, BP1, and BP2 in the status register 152. In step 908, the control logic 130 will proceed with determining whether the targeted address is write protected by checking the protection bits. As shown in table 700, the three protection bits BP0, BP1, and BP2 in the status register 152 define whether none, ⅛, ¼, ½, or all of the memory array 110 is write protected. If the targeted address does not lie in a protection region, then the requested erase command is performed in step 910. If the targeted address is protected, then the requested erase is refused in step 911. The desired erase command can be performed if a Write Configuration Register (WRCR) command is issued to change the status register bits so as to unprotect the targeted address.

In the embodiment described above, the memory array 110 of the flash memory device 100 includes one or more sectors that can be dynamically configured into a plurality of subsectors. The finer granularity sector size architecture can enable a user to update data more efficiently. In some applications, this subsector feature can also eliminate the need for additional serial EEPROM for storing user data.

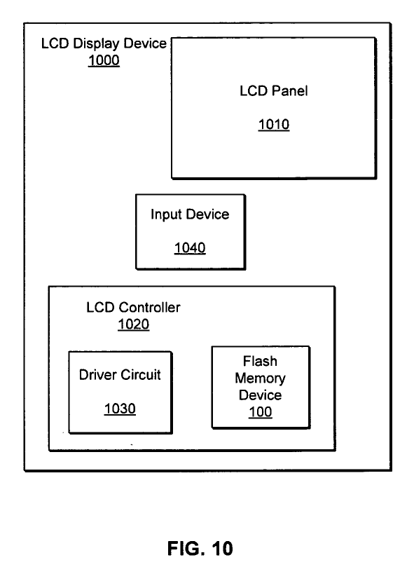

FIG. 10 shows one application in which a flash memory device 100 is implemented as part of a Liquid Crystal Display (LCD) device 1000. The LCD display device 1000 comprises an LCD panel 1010 and an LCD controller 1020. The LCD controller 1020 comprises the flash memory device 100 and a driver circuit 1030, which may comprise a microcontroller unit (MCU). An input device 1040, such as an IR reader, touchpad, or control buttons, may be used for receiving setting inputs from a user.

The flash memory device 100 is used to store the code used by the driver circuit 1030 for operating the LCD display device 1000 and for storing user configuration settings for the display device 1000, such as, e.g., brightness, contrast, program channels, etc. In this embodiment, it is desirable to have a small amount of space in the memory array 110 set aside for storing the user configuration settings. In order to avoid inadvertently erasing any of the code data, it would be desirable for this small region to be separately protectable from the remainder of the memory array 110. Thus, the bottom sector (Sector 0) is used to store the user data. The protection scheme defined by the protection bits in the status register can be used to write protect all of the memory array 110 except Sector 0. The write protection of Sector 0 is established by the protection scheme defined by the configuration register 150, as described above.

When it is desired to change a user setting, the driver circuit 1030 will issue a WRCR instruction to change the SCFG bit in the configuration register 150 to “1” in order to enable the subsector access. This WRCR instruction can also be used to change the protection bit corresponding to the targeted address (SP0_0, SP0_1, SP0_2, or SP0_3 in the configuration register 150) to “0” in order to unprotect the targeted address. Because the subsector access has been enabled, the driver circuit 1030 is able to unprotect the targeted subsector without having to also unprotect any other regions in the memory array 110. In particular, the regions of the memory array 110 which store the operational code for the display device 1000 remain protected. Finally, the driver circuit 1030 will issue a PAGE_PROG instruction to store the desired data in the targeted subsector.

In the embodiments described above, the configuration register 150 is stored using volatile data latches. As a result, if the flash device 100 is powered down, the settings in the configuration register 150 will be lost. Thus, the subsectors will no longer be available and the default protection scheme will apply. The microcontroller must change the SCFG bit back to “1” in order to enable the subsector feature again. The use of data latches for storing the configuration register 150 may be desirable because the values in the latch may be changed more rapidly than the values in the flash memory array 110. In addition, the access time for the latches is shorter than the access time for the flash memory array 110. However, in other embodiments, the configuration register 150 may be stored elsewhere, such as in a portion of the memory array 110 or in an EEPROM.

While the invention has been described in terms of particular embodiments and illustrative figures, those of ordinary skill in the art will recognize that the invention is not limited to the embodiments or figures described. For example, in many of the embodiments described above, only a single sector (Sector 0) is reconfigurable into multiple subsector regions. In other embodiments, a plurality or all of the sectors in the memory array 110 may be reconfigurable into subsector regions. In these embodiments, the configuration register 150 may store a single subsector enable bit corresponding to the reconfigurable region of the memory array 110. For example, there may be a subsector enable bit corresponding to each sector in the memory array 110, whereby each sector may be individually configured to be treated as a single sector or a multiple subsectors. In addition, each of these subsectors may be provided with a protection bit that enables write protection to be applied to each subsector individually. In other embodiments, the configuration register 150 may store a single subsector enable bit corresponding to a reconfigurable region including multiple sectors. Thus, when the subsector enable bit is enabled, all of the sectors within that reconfigurable region will be divided into multiple subsectors.

In addition, in tables 600 and 700 shown in FIGS. 6 and 7, three status register bits BP0, BP1, and BP2 are used for controlling the write protection for the memory array 110. In other embodiments, greater or fewer protection bits may be used. For example, in one embodiment, only two protection bits, BP0 and BP1, are stored in the status register. These two protection bits can be used to define four different protection states, which can be, e.g., all sectors unprotected, upper ¼ sectors protected, upper ½ sectors protected, and all sectors protected.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of storing data in a flash memory device comprising a memory array, said memory array comprising a plurality of memory sectors, wherein at least one of the memory sectors comprises a plurality of subsectors, said method comprising:
receiving an instruction to erase an address contained in one of the plurality of subsectors;
checking a subsector enable bit in a configuration register;
if the subsector enable bit is not enabled, applying a first protection scheme to determine write protection of the address; and
if the subsector enable bit is enabled, applying a second protection scheme to determine write protection of the address, wherein the second protection scheme permits the control logic to unprotect a single subsector without unprotecting a remainder of the memory array.

2. The method of claim 1, wherein:
said second protection scheme comprises a plurality of subsector protection bit, each of the subsector protection bits indicating a write protect state of one of the plurality of subsectors.

3. The method of claim 1, further comprising:
storing executable code in the plurality of sectors; and
storing configuration setting data in the plurality of subsectors.

4. The method of claim 3, wherein:
said executable code comprises code for operating a display device; and
said configuration setting data comprises configuration settings for the display device.

5. A flash memory circuit, comprising:
a memory array comprising a plurality of memory sectors, wherein at least one of the memory sectors comprises a plurality of subsectors;
a status register array comprising a plurality of protection bits defining a protection scheme for the memory array;
a configuration register array defining a protection scheme for the plurality of subsectors, said configuration register comprising a subsector enable bit and a plurality of subsector protection bits; and
control logic for controlling storage of data on the memory array.

6. The flash memory circuit of claim 5, wherein:
said control logic is configured such that enabling of the subsector enable bit allows the control logic to unprotect one of the subsectors without unprotecting a remainder of the memory array.

7. The flash memory circuit of claim 5, wherein:
said control logic is configured to check the subsector enable bit in response to receipt of an erase or program command targeting an address corresponding to one of the subsectors.

8. The flash memory circuit of claim 5, wherein:
said control logic is configured to check the subsector enable bit in response to receipt of an erase or program command targeting an address corresponding to one of the subsectors, and if the subsector enable bit is enabled, the control logic checks the subsector protection bit corresponding to the targeted address, and if the subsector enable bit is not enabled, the control logic checks the protection bit in the status register corresponding to the targeted address.

9. The flash memory circuit of claim 5, wherein:
said plurality of memory sectors store executable code; and
said plurality of subsectors store configuration setting data.

10. The flash memory circuit of claim 9, wherein:
said executable code comprises code for operating a display device; and
said configuration setting data comprises configuration settings for the display device.

11. A flash memory circuit, comprising:
a memory array comprising a plurality of memory sectors, wherein at least one of the memory sectors comprises a plurality of subsectors;
a configuration register array comprising a subsector enable bit; and
control logic for controlling storage of data on the memory array, said control logic configured such that if the subsector enable bit is enabled, the control logic performs erase instructions on a subsector level, and if the subsector enable bit is disabled, the control logic performs erase instructions on a sector level.

12. The flash memory circuit of claim 11, wherein:
said configuration register array further comprises:
one or more protection bits defining a first protection scheme for the memory array; and
a plurality of subsector protection bits defining a second protection scheme for the plurality of subsectors; and
said control logic is configured to check the subsector enable bit in response to an erase instruction for one of the subsectors, such that if the subsector enable bit is disabled, the control logic will perform the erase instruction pursuant to the first protection scheme, and if the subsector enable bit is enabled, the control logic will perform the erase instruction pursuant to the second protection scheme.

13. The flash memory circuit of claim 11, wherein:
said plurality of memory sectors store executable code; and
said plurality of subsectors store configuration setting data.

14. The flash memory circuit of claim 13, wherein:
said executable code comprises code for operating a display device; and
said configuration setting data comprises configuration settings for the display device.
